(19) United States
(12) Patent Application Publication
(10) Pub. No.: US 2013/0093297 A1
(43) Pub. Date: Apr. 18, 2013

(54) DEVICE HOUSING AND METHOD FOR MAKING THE SAME

(71) Applicants: XIN-WU GUAN, Shenzhen City (CN); CHAO-SHENG HUANG, Shenzhen City (CN); XIAO-MEI CHEN, Shenzhen City (CN)

(72) Inventors: XIN-WU GUAN, Shenzhen City (CN); CHAO-SHENG HUANG, Shenzhen City (CN); XIAO-MEI CHEN, Shenzhen City (CN)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 13/571,014

(22) Filed: Aug. 9, 2012

(30) Foreign Application Priority Data
Oct. 13, 2011 (CN) 201110309718.5

(51) Int. Cl. B32B 38/14; A47B 96/00; B29C 65/02

(52) U.S. Cl. 312/204; 156/285; 156/277

(57) ABSTRACT

A device housing includes a main body and a first decorative layer formed on the main body. The main body defines a planar region and at least a concave region connected with the planar region. The first decorative layer includes a first pattern and a second pattern. The first pattern is formed on the planar region. The second pattern is formed on the concave region. The first pattern and the second pattern are an integral structure. A method for making the device housing is also provided.

### BACKGROUND

1. Technical Field

The present disclosure relates to device housing and a method for making the device housing.

2. Description of Related Art

Electronic devices, such as mobile phones and personal digital assistants, commonly include housings having decorative films. The decorative films may be adhered to the surfaces of the housings. However, when the surfaces of the housings are concave or convex, it is difficult to smoothly combine the decorative films on the housings.

Therefore, there is room for increasement within the art.

### BRIEF DESCRIPTION OF THE DRAWINGS

Many aspects of the disclosure can be better understood with reference to the following figures. The components in the figures are not necessarily drawn to scale, the emphasis instead being placed upon clearly illustrating the principles of the disclosure. Moreover, in the drawings, like reference numerals designate corresponding parts throughout the several views.

FIG. 1 is a cross-sectional view of an exemplary embodiment of a device housing.

FIG. 2 is a schematic view of an exemplary embodiment of a film application machine.

FIG. 3 is a schematic view of the film application machine shown in FIG. 2 at a first working status.

FIG. 4 is a schematic view of the film application machine shown in FIG. 2 at a second working status.

FIG. 5 is a schematic view of the film application machine shown in FIG. 2 at a third working status.

FIG. 6 is a schematic view of the film application machine shown in FIG. 2 at a fourth working status.

### DETAILED DESCRIPTION

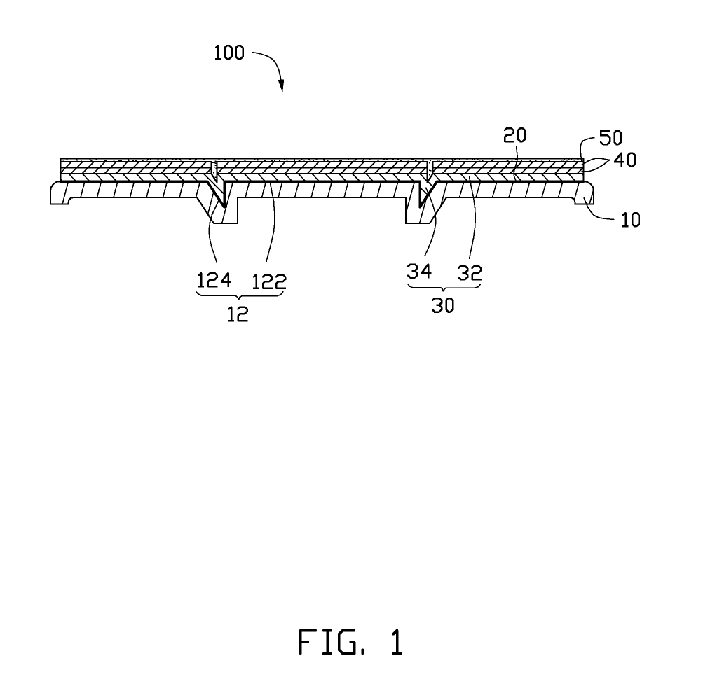

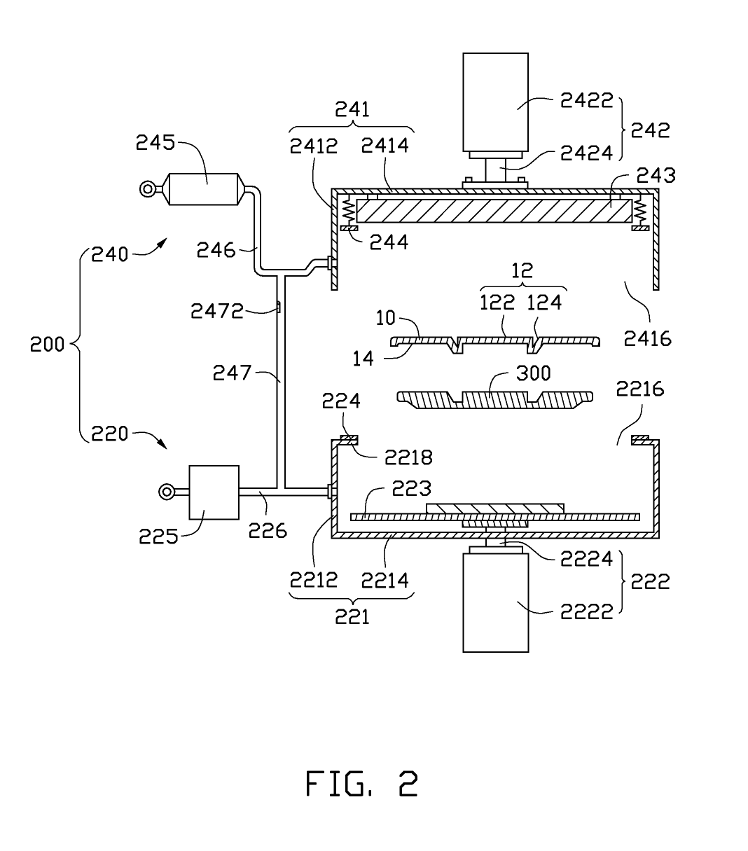

Referring to FIGS. 1 and 2, a device housing 100 according to an exemplary embodiment includes a main body 10, a bonding layer 20 directly formed on the main body 10, a first decorative layer 30 directly formed on the bonding layer 20, and a plurality of second decorative layers 40 directly formed on the first decorative layer 30.

The main body 10 includes a first surface 12 and a second surface 14 opposite to the first surface 12. The first surface 12 defines a planar region 122 and a plurality of concave regions 124 connected with the planar region 122. A plurality of notches of the main body 10 are defined in the concave regions 124. The bonding layer 20 is directly formed on and bonded to the first surface 12.

The first decorative layer 30 includes a first pattern 32 directly formed on the planar region 122 and a second pattern 34 directly formed on the concave regions 124. The first pattern 32 and the second pattern 34 are an integral structure. The second decorative layers 40 may include two layers. The second decorative layer 40 may be an ink printing layer and directly formed on the first pattern 32.

The device housing 100 may further includes a transparent or translucent protective layer 50 directly formed on the second pattern 34 and the second decorative layers 40. The protective layer 50 may be a paint layer or an ink layer which is used to protect the first and second decorative layers from scratches.

A method for making the device housing 100 may include the following steps.

Referring to FIG. 2, a film application machine 200 is provided. The film application machine 200 includes a lower mold assembly 220 and an upper mold assembly 240.

The lower mold assembly 220 includes a lower receiver 221, a first driver 222, a fastening plate 223, two first catching elements 224, and a vacuum pump 225. The lower receiver 221 includes a first peripheral wall 2212 and a bottom wall 2214 connected to the first peripheral wall 2212. The first peripheral wall 2212 and the bottom wall 2214 enclose a cylindrical first cavity 2216. Two flanges 2218 are oppositely protruded from the inner surface of the first peripheral wall 2212.

The first driver 222 passes through the bottom wall 2214 and connects with the fastening plate 223. The first driver 222 moves the fastening plate 223 up and down. In the embodiment, the first driver 222 is a cylinder which includes a first cylinder body 2222 and a first piston 2224 retractably positioned in the first cylinder body 2222. The first cylinder body 2222 may be supported by a rack (not shown). The first piston 2224 passes through the bottom wall 2214 and connects with the fastening plate 223 to move the fastening plate 223.

The fastening plate 223 is for supporting and fixing the main body 10. Each first catching element 224 is fastened on the side of each flange 2218, away from the bottom wall 2214.

The lower mold assembly 220 further includes a first tube 226. The first tube 226 connects the vacuum pump 225 to the first cavity 2216 of the lower receiver 221.

The upper mold assembly 240 includes an upper receiver 241, a second driver 242, a heating element 243, two second catching elements 244, and an air providing device 245. The upper receiver 241 includes a second peripheral wall 2412 and a top wall 2414 connected to the second peripheral wall 2412. The second peripheral wall 2412 and the top wall 2414 enclose a cylindrical second cavity 2416.

The second driver 242 connects with the top wall 2414 to move the upper receiver 241 up and down. In the embodiment, the second driver 242 is also a cylinder which includes a second cylinder body 2422 and a second piston 2424 retractably positioned in the second cylinder body 2422. The second piston 2424 is connected with the top wall 2414 to move the upper receiver 241.

The heating element 243 locates in the second cavity 2416 and adjacent to the top wall 2414. The two second catching elements 244 are located in the second cavity 2416 and fastened on the top wall 2414 by springs. The second catching elements 244 may be driven by a third driver (not shown) to move relative to the upper receiver 241. The third driver can also be a cylinder.

The upper mold assembly 240 further includes a second tube 246 and a third tube 247. The second tube 246 connects the air providing device 245 and the second cavity 2416 of the upper receiver 241, which allows the air providing device 245 to feed air to the second cavity 2416 to increase the air pressure of the second cavity 2416. The third tube 247 connects the first tube 226 and the second tube 246. A valve 2472 is formed in the third tube 247 to turn on or turn off the third tube 247.

A fastening member 300 is provided. The fastening member 300 has a shape mating with the main body 10. The main body 10 is located in the fastening member 300 by the second surface 14 directly contacting with the fastening member 300. The fastening member 300 having the main body 10 is positioned in the lower receiver 221 and fixed on the fastening plate 223.

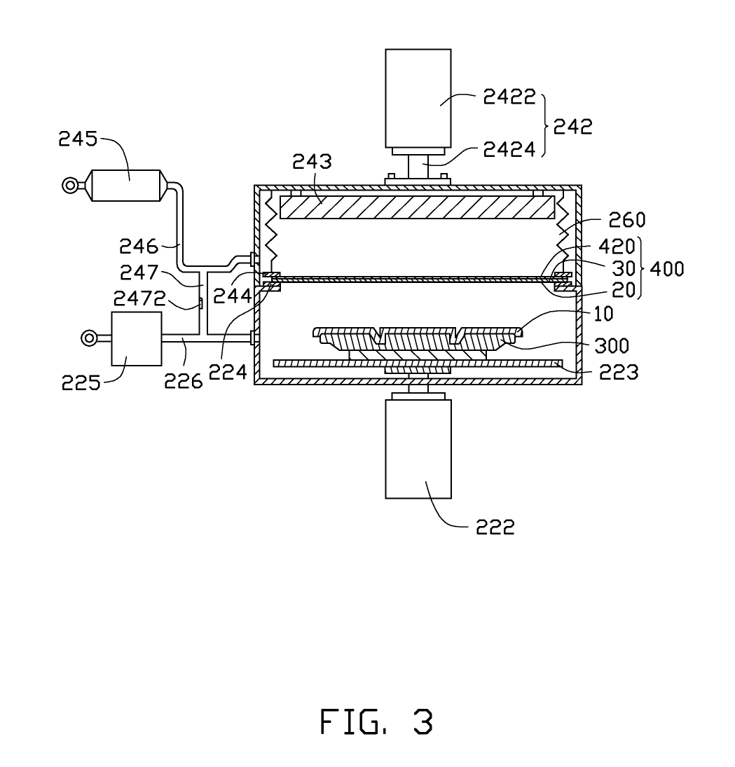

Referring to FIG. 3, a decorative film 400 is provided. The decorative film 400 includes the bonding layer 20, the first decorative layer 30 bonding with the bonding layer 20, and a split layer 420 cover on the first decorative layer 30. The decorative film 400 is attached on the two first catching elements 224 by the adhering between the bonding layer 20 and the first catching elements 224.

The second driver 242 is started. The second piston 2424 drives the upper receiver 241 to move towards the lower receiver 221. When the second peripheral wall 2412 of the upper receiver 241 resists against the first peripheral wall 2212 of the lower receiver 221, the first cavity 2216 and the second cavity 2416 connect together and form a sealed chamber 260. The second catching elements 244 are driven by the third driver to further move to the first catching elements 224 to catch the decorative film 400 between the first and the second catching elements.

The valve 2472 of the third tube 247 is turned on. The vacuum pump 225 is started to evacuate the sealed chamber 260.

The heating element 243 is started to heat the decorative 400 and make the decorative 400 soften.

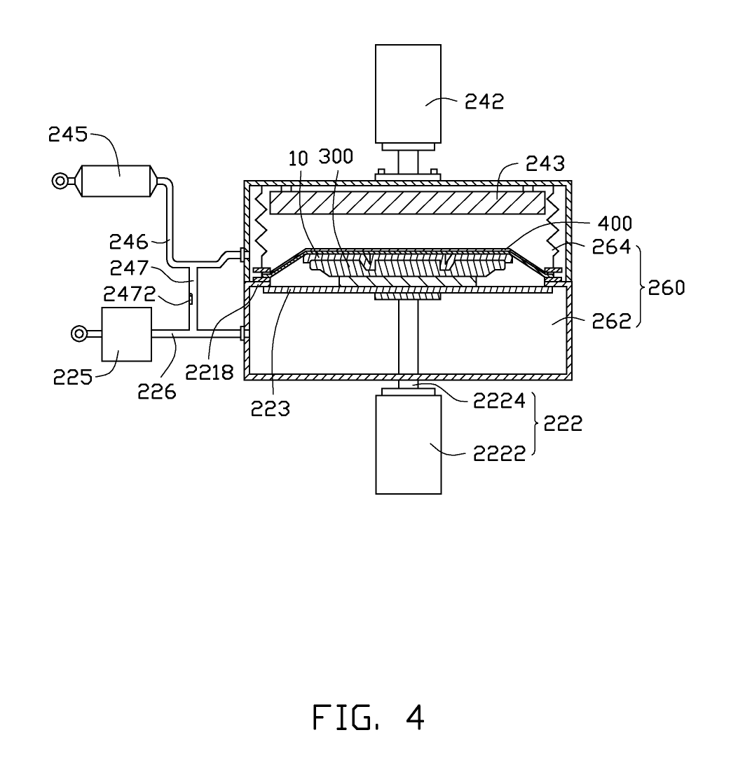

Referring to FIG. 4, the first driver 222 is started. The first piston 2224 drives the fastening plate 223 and the main body 10 to move towards the upper receiver 241 to allow the fastening plate 223 resisting again the flanges 2218. At this time, the sealed chamber 260 is divided into a first sealed cavity 262 and a second sealed cavity 264 by the fastening plate 223. The decorative film 400 is urged by the main body 10 to be tightly spread. The tightly spread decorative film 400 then tightly attaches on the main body.

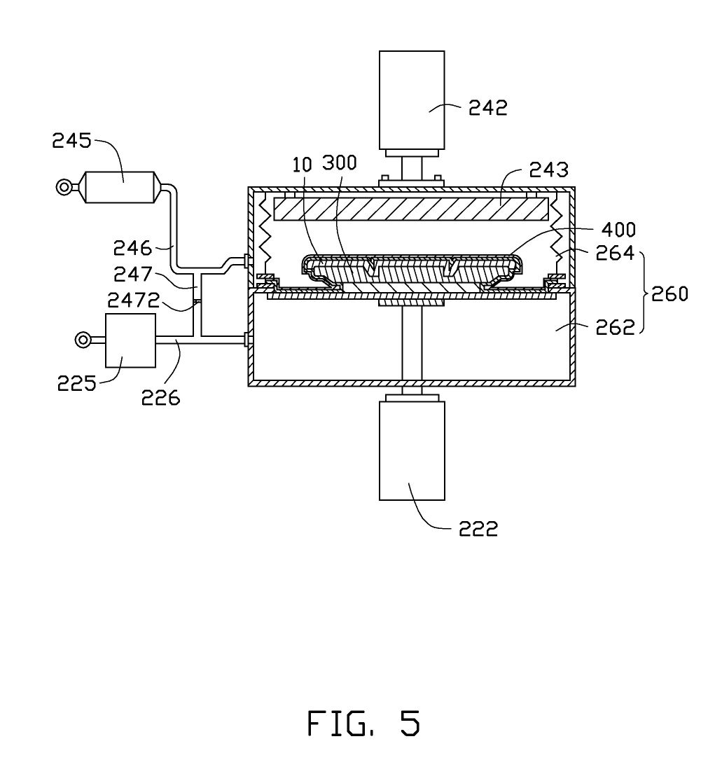

Referring to FIG. 5, the valve 2472 is turned off. The air providing device 245 is started to feed the second sealed cavity 264 air via the second tube 246 to increase the air pressure of the second sealed cavity 264. As a result, the air pressure of the second sealed cavity 264 is higher than the air pressure of the first sealed cavity 262, thus a pressure difference is created between the two sides of the decorative film 400. The pressure difference helps the decorative film 400 completely bond on the planar region 122 and the concave regions 124 of the main body 10.

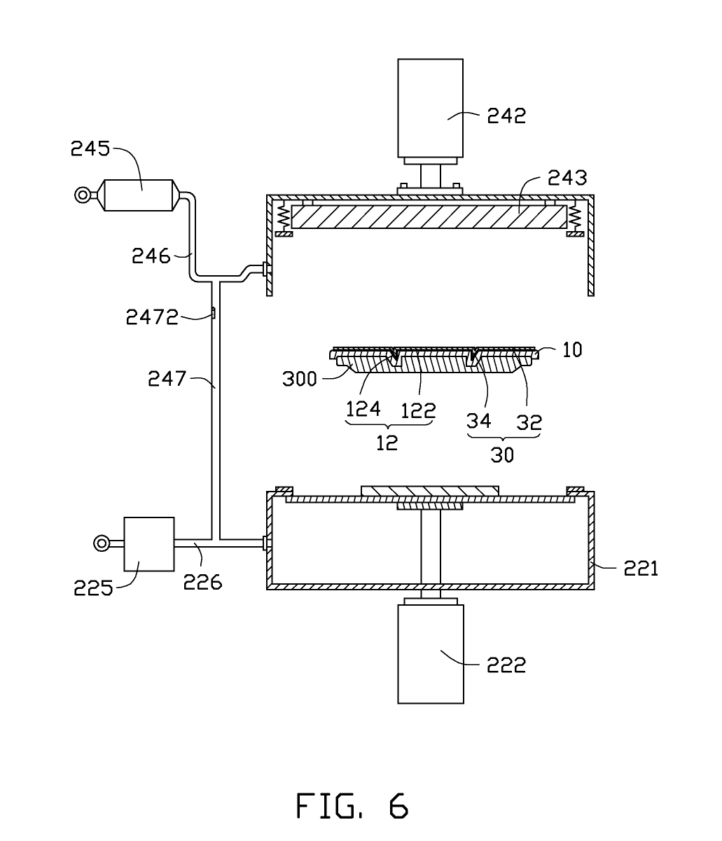

Referring to FIG. 6, when the decorative film 400 is combined to the main body 10, the upper receiver 241 moves away from the lower receiver 221. The fastening member 300 and the main body 10 are removed from the fastening plate 223.

The fastening member 300 and the main body 10 may be baked in an ultraviolet oven (not shown). When the first decorative layer 30 is solidified, the fastening member 300 and the main body 10 are removed from the oven. The split layer 420 is then split from the first decorative layer 30. As such, the first pattern 32 is formed on the planar region 122 of the main body 10, and the second pattern 34 is formed on the concave regions 124.

The second decorative layers 40 may be overprinted on the first pattern 32 to complete the device housing 100. The second decorative layers 40 and the first pattern 32 may have same or similar patterns.

The protective layer 50 may be further applied on the second decorative layers 40 and the second pattern 34 to protect the first decorative layer 30 and the second decorative layer 40 from being scratched.

The decorative film 400 of the exemplary embodiment can be smoothly bonded on the concave regions 124 and the planar region 122 of the main body 10 to from the first decorative layer 30. Additionally, the planar region 122 is covered with the first pattern 32 and the second decorative layers 40. Meanwhile the concave regions 124 are only covered with the second pattern 34, with which a visual contrast is created at the planar and concave regions and makes the device housing 100 present a three-dimensional appearance.

It is believed that the exemplary embodiment and its advantages will be understood from the foregoing description, and it will be apparent that various changes may be made thereto without departing from the spirit and scope of the disclosure or sacrificing all of its advantages, the examples hereinbefore described merely being preferred or exemplary embodiment of the disclosure.

What is claimed is:

1. A device housing, comprising:
a main body comprising a planar region and at least a concave region connecting with the planar region; and
a first decorative layer comprising a first pattern formed on the planar region and a second pattern formed on the concave region, the first pattern and the second pattern being an integral structure.

2. The device housing as claimed in claim 1, further comprising at least a second decorative layer formed on the first pattern.

3. The device housing as claimed in claim 2, wherein the second decorative layer and the first pattern have substantially the same pattern.

4. The device housing as claimed in claim 2, further comprising a transparent or translucent protective layer formed on the second pattern and the second decorative layer.

5. The device housing as claimed in claim 4, wherein the protective layer is a paint layer or an ink layer.

6. The device housing as claimed in claim 1, further comprising a bonding layer formed between the main body and the first decorative layer.

7. A method for making a device housing, comprising:
providing a film application machine, the film application machine comprising:
a lower mold assembly; and
an upper mold assembly for mating with the lower mold assembly;
the lower mold assembly comprising:
a lower receiver;
a fastening plate received in the lower receiver;
a first driver connecting with the lower receiver for driving the fastening plate to move; and
a vacuum pump connecting to the lower receiver;
the upper mold assembly comprising:
an upper receiver;
a heating element mounted in the upper receiver; and
an air providing device connecting to the upper receiver;
providing a main body comprising a planar region and at least a concave region connecting with the planar region;
positioning the main body on the fastening plate;
providing a decorative film comprising a first decorative layer, the first decorative layer comprising a first pattern and a second pattern;
attaching the decorative film on the lower receiver to position the first pattern upon the planar region of the main body and the second pattern upon the concave region;
forming a sealed chamber between the upper receiver and the lower receiver by mating the upper receiver and the lower receiver;
evacuating the sealed chamber by the vacuum pump;
softening the decorative film by heating of the heating element;
moving the main body by the first driver to resist against the decorative film, the sealed chamber being divided into a first sealed cavity in the lower receiver and a second sealed cavity in the upper receiver;
feeding the second sealed cavity air by the air providing device to create a pressure difference between the two sides of the decorative film to allow the first pattern bonding on the planar region and the second pattern bonding on the concave region.

8. The method as claimed in claim 7, wherein the method further comprises a step of overprinting at least a second decorative layer on the first pattern, the second decorative layer and the first pattern have same patterns.

9. The method as claimed in claim 8, wherein the method further comprises a step of forming a protective layer on the second pattern and the second decorative layer.

10. The method as claimed in claim 9, wherein the protective layer is a paint layer or an ink layer.

11. The method as claimed in claim 7, wherein the decorative layer further comprises a bonding layer, the bonding layer bonds the first decorative layer to the main body.

12. The method as claimed in claim 7, wherein the lower mold assembly further comprises two first catching elements fixed on the lower receiver, the upper mold assembly further comprises two second catching elements positioned in the upper receiver, the first and the second catching elements catch the two ends of the decorative film to fix the decorative film on the lower receiver.

13. The method as claimed in claim 7, wherein the lower receiver comprises a first peripheral wall and a bottom wall connected to the first peripheral wall, the first peripheral wall and the bottom wall enclose a first cavity, the first sealed cavity is formed in the first cavity.

14. The method as claimed in claim 12, wherein two flanges are oppositely protruded from the inner surface of the first peripheral wall, the two first catching elements are fixed on the two flanges, when the fastening plate resists against the flanges the sealed chamber is divided into the first sealed cavity and the second sealed cavity.

15. The method as claimed in claim 13, wherein the first driver passes through the bottom wall and connects the fastening plate to move the fastening plate up and down.

16. The method as claimed in claim 7, wherein the upper mold assembly further comprises a second driver connecting the upper receiver, the second driver moves the upper receiver up and down.

17. The method as claimed in claim 16, wherein the upper receiver comprises a second peripheral wall and a top wall connected to the second peripheral wall, the second driver connects the top wall to move the upper receiver up and down.

18. The method as claimed in claim 17, wherein the second catching elements are fastened on the top wall of the upper receiver by springs.

19. The method as claimed in claim 7, wherein the main body is positioned on the fastening plate by a fastening member, the fastening member has a shape mating with the main body.

20. The method as claimed in claim 7, wherein the vacuum pump is connected to the lower receiver by a first tube, the air providing device is connected to the upper receiver by a second tube, and a third tube formed a valve therein connects the first tube and the second tube.
